(19) United States
(12) Patent Application Publication
(10) Pub. No.: US 2026/0049040 A1
(43) Pub. Date: Feb. 19, 2026

(54) NANO UREA FERTILISER AND METHOD OF MANUFACTURE THEREOF

(71) Applicant: INDIAN FARMERS FERTILISER COOPERATIVE LIMITED, New Delhi (IN)

(72) Inventors: Arunachalam LAKSHMANAN, New Delhi (IN); Udai Shanker AWASTHI, New Delhi (IN); Yogendra KUMAR, New Delhi (IN); Birinder SINGH, New Delhi (IN); Deepak Gajanan INAMDAR, New Delhi (IN); Tarunendu SINGH, New Delhi (IN)

(73) Assignee: INDIAN FARMERS FERTILISER COOPERATIVE LIMITED, New Delhi (IN)

(21) Appl. No.: 19/103,844

(22) PCT Filed: Jul. 1, 2023
(86) PCT No.: PCT/IN2023/050639

§ 371 Date: Feb. 14, 2025

(30) Foreign Application Priority Data
Jan. 12, 2023 (IN) 202311001128

(51) Int. Cl. C05C 9/00; C05B 7/00; C05C 3/00; C05C 11/00; C05D 9/02; C05G 3/50; C05G 3/60; C05G 5/27

(52) U.S. Cl. CPC C05C 9/005; C05B 7/00; C05C 3/005; C05C 11/00; C05D 9/02; C05G 3/50; C05G 3/60; C05G 5/27

(57) ABSTRACT

The present invention relates to aqueous fertiliser compositions containing stabilized nano clusters of ≤100 nm and preparation thereof. The aqueous fertiliser compositions containing stabilized nano clusters of ≤100 nm comprising sources of nitrogen such as urea optionally in combination with thiourea, a first ammonium salt, a second ammonium salt either alone or in combination, non-ionic surfactant. amino acid. polymer matrix, and optionally acids and antimicrobial agents. The aqueous fertilizer compositions are stable and retain their characteristics during storage even at temperatures up to 50° C. and maintains the zeta potential of <−25 mV. The nano urea formulation exhibits static contact angle of 40° to 50°, with the surface tension of the droplets ranging between 20 to 30 mN/m thereby enhancing their spreadability and efficacy. The present invention further provides a process for the production of the said aqueous fertilizer compositions.

### FIELD OF THE INVENTION

The present invention relates to aqueous fertiliser compositions containing stabilized nano clusters of ≤100 nm and preparation thereof. The present invention further relates to stable aqueous fertiliser compositions containing stabilized nano clusters of ≤100 nm comprising sources of nitrogen such as urea optionally in combination with thiourea, a first ammonium salt, a second ammonium salt either alone or in combination, non-ionic surfactant, amino acid, polymer matrix, and optionally acids and antimicrobial agents.

### BACKGROUND OF THE INVENTION

Clean and efficient management of the nitrogen nutrition in plants continues to be a challenge in agriculture. Use of nitrogen containing fertilizers with varying effectiveness has been a common practice. Several factors influence uptake of nitrogenby plants during foliar fertilization. Fertilizers with low nitrogen use efficiency not only result in drop inagricultural productivity, but also leave reactive nitrogen residues, leading to enhanced environmental pollution. Though nano urea compositionsin prior art are known to partially mitigate such issues, their instability due toprecipitation, phase separation and ammonia gas release, leads to shorter shelf-life and poses serious limitations to their effective industrial production and usage in large scale agricultural operations.

It has surprisingly been found that the chemical and physical stability, shelf-life and bio-efficacy of aqueous fertiliser compositions containing stabilized nano clusters of ≤100 nm and their spreadability on leaves can be significantly enhanced by judiciously incorporating urea along with nitrogen containing chemical entities in tailored matrices to retain their cluster sizes in the nano range in the compositions, even when exposed to temperatures up to 50° C., and used under different field application methods such as seed treatment, seedling dip and foliar spray.

### OBJECTS OF THE PRESENT INVENTION

The main object of the invention is to provide aqueous fertiliser compositions containing stabilized nano clusters of ≤100 nm.

Another object of the present invention is to provide aqueous fertiliser compositions containing stabilized nano clusters of ≤100 nm comprising nitrogen sources such as urea optionally with thiourea, ammonium and nitrate containing chemical entities, either singly or in any combination.

Yet another object of the present invention is to provide the said aqueous fertiliser compositions containing stabilized nano clusters of ≤100 nm by judiciously incorporating the nitrogen containing chemical entities in tailored matrices, to retain the size, zeta and stability of the compositions.

Yet another object of the invention is to provide the said aqueous fertiliser compositions that are storage stable to prevent the agglomeration of the nano clusters, to maintain the size of the nano clusters less than 100 nm.

Yet another object of the invention is to stabilize the pH of the said aqueous fertiliser compositions during storage under elevated temperatures up to 50° C.

Yet another object of the present invention is to provide the said aqueous fertiliser compositions, wherein the sizes of the nano clusters, Zeta potential, pH and physical characteristics of the compositions, including appearance remain unchanged during storage even at temperature up to 50° C.

Yet another object of the present invention is to provide the said stable aqueous fertiliser compositions, without phase separation, precipitation and gel formation during storage.

Yet another object of the present invention is to provide the said aqueous fertiliser compositions with high spreadability on diverse substrates to ensure enhanced absorption and bioefficacy, when used under different field application methods such as seed treatment, seedling dip and foliar spray.

Yet another object of the invention is to provide the said aqueous fertiliser compositions that are eco and bio safe, and do not show any toxic effect on beneficial organisms such as honey bees and natural predators in agriculture.

Yet another object of the invention is to provide commercially cost effective scalable process for manufacture of the said aqueous fertiliser compositions.

Yet another object of the invention is to incorporate multi-functional chemical moieties such as amino, nitrogen, sulphur, boron, etc. in the nano clusters of the aquous fertilizer compositions.

### SUMMARY OF THE INVENTION

The present invention relates to aqueous fertiliser compositions containing stabilized nano clusters of ≤100 nm and preparation thereof. The present invention further relates aqueous fertiliser compositions containing stabilized nano clusters of ≤100 nm comprising sources of nitrogen such as urea optionally in combination with thiourea, a first ammonium salt, a second ammonium salt either alone or in combination, non-ionic surfactant, amino acid, polymer matrix, and optionally acid and antimicrobial agents. The active nitrogen containing sources are dissolved in sequence in an aqueous media, judiciously treated with non-ionic surfactant and incorporated in polymer matrices to produce stabilized nano clusters of less than 100 nm. The non-ionic surfactants are selected from polysorbates or polyglycerol or sorbiton or poly ethylene glycol. The polymer matrices are prepared using polymers selected from Gum Arabic or Gum acacia and pectin in combination with anionic polymers preferably sodium carboxy methylcellulose (CMC), hydroxy propyl methyl cellulose and poly vinyl alcohol. Amino acids are further added, followed by optional addition of acids and antimicrobials. The stable nano fertilizer compositions of the present invention retain their characteristics during storage even at temperatures up to 50° C. These judiciously prepared aqueous fertilser compositions with HLB values ranging from 10.0 to 12.0 exhibits desirable contact angle of the droplets on diverse substrates on spraying, thereby enhancing their absorption efficiency and bio efficacy when used under different field application methods such as seed treatment, seedling dip and foliar spray. The aqueous media is selected from water, or a mixture of water and organic solvent, wherein the organic solvent is up to 10% w/v of the aqueous media The present invention further provides a process for the production of the said aqueous fertiliser compositions. Optionally, multi-functional chemical moieties such as amino, nitrogen, sulphur, boron, etc. maybe incorporated in the composition.

### BRIEF DESCRIPTION OF FIGURES

FIG. 1: illustrates particle size distribution of aqueous fertiliser composition of present invention by Dynamic Light Scattering;

FIG. 2: illustrates Zeta potential of aqueous fertiliser composition of present invention by DLS;

FIG. 3: TEM image of aqueous fertiliser composition of present invention by TEM;

FIG. 4: Particle size distribution and zeta potential of aqueous fertiliser composition of present invention of example. 1;

FIG. 5: Particle size distribution and zeta potential of aqueous fertiliser composition of present invention of example. 2;

FIG. 6: Particle size distribution and zeta potential of aqueous fertiliser composition of present invention of example. 3;

FIG. 7: Particle size distribution and zeta potential of Nano urea of example. 4;

FIG. 8: Particle size distribution and zeta potential of aqueous fertiliser composition of present invention of example. 5;

FIG. 9: Particle size distribution and zeta potential of aqueous fertiliser composition of present invention of example. 6;

FIG. 10: Particle size distribution and zeta potential of aqueous fertiliser composition of present invention of example. 7;

FIG. 11: Particle size distribution and zeta potential of aqueous fertiliser composition of present invention of example. 8;

FIG. 12: Particle size distribution and zeta potential of aqueous fertiliser composition of present invention of example. 9;

FIG. 13: Particle size distribution and zeta potential of aqueous fertiliser composition of present invention of example. 10;

FIG. 14: Particle size distribution and zeta potential of aqueous fertiliser composition of present invention of example. 11;

FIG. 15: Particle size distribution and zeta potential of aqueous fertiliser composition of present invention of example. 12;

FIG. 16: Effect of diluted aqueous fertiliser composition of present invention of example 2 on Seed Vigour Index in Maize;

FIG. 17: Effect of diluted aqueous fertiliser composition of present invention of example 7 on Seed Vigour Index in Maize;

FIG. 18: Effect of diluted aqueous fertiliser composition of present invention of example 8 on Seed Vigour Index in Maize;

FIG. 19: Contact angle of Diluent on Zea mays leaf;

FIG. 20: Contact angle of 2% Urea on Zea mays leaf;

FIG. 21: Contact angle of diluted aqueous fertiliser composition of example 5 on Zea mays leaf;

FIG. 22: Dynamic contact angle of water Dated: 24.06.2023;

FIG. 23: Dynamic contact angle of diluted aqueous fertiliser composition of example 5.

### DETAILED DESCRIPTION OF THE INVENTION

It has surprisingly been found that the chemical and physical stability, shelf-life and bio-efficacy of aqueous fertiliser compositions containing stabilized nano clusters of ≤100 nm and their spreadability on leaves can be significantly enhanced by judiciously incorporating urea along with nitrogen containing chemical entities in tailored matrices to retain their cluster sizes in the nano range in the compositions, even when exposed to temperatures up to 50° C., and used under different field application methods such as seed treatment, seedling dip and foliar spray.

The aqueous media is selected from water, or a mixture of water and organic solvent, wherein the organic solvent is up to 10% w/v of the aqueous media

The nitrogen containing chemical entities in the present invention are selected from urea, thio urea, a first ammonium salt selected from mono ammonium phosphate, di ammonium phosphate, a second ammonium salt selected from ammonium sulphate, ammonium nitrate, either alone or in combination.

In one aspect of the invention, the ratio of the nitrogen containing chemical entities, i.e., (urea):(first ammonium salt):(second ammonium salt) is (2-6):(1-2):(1-4).

In another aspect of the invention, the ratio of the nitrogen containing chemical entities comprises (Urea):(first ammonium salt):(second ammonium salt) is (1-7):(1-7):(1-7).

Yet another aspect of the invention, the ratio of the nitrogen containing chemical entities comprises (Urea):(Thio Urea) is (1-8):(1-4).

Yet another aspect of the invention, the ratio of the nitrogen containing chemical entities comprise (Urea):(first ammonium salt) is (1-4):(1-3)

Yet another aspect of the invention, the ratio of the nitrogen containing chemical entities comprise (Urea):(second ammonium salt) is (1-10):(1-10)

Yet another aspect of the invention, the ratio of the nitrogen containing chemical entities containing (Urea):(Thio Urea):(first ammonium salt) is (1-6):(1-3):(1-4)

Yet another aspect of the invention, the ratio of the nitrogen containing chemical entities containing (Urea):(Thio Urea):(second ammonium salt) is (1-5):(1-4):(1-4)

Yet another aspect of the invention, the ratio of the nitrogen containing chemical entities containing (Urea):(Thio Urea):(first ammonium salt):(second ammonium salt) is (0.5-30):(0.5-3):(1-30):(1-30).

In a preferred aspect of the invention, the nitrogen containing chemical entities are treated with non-ionic surfactants such as Polysorbates or polyglycerol (0.5-2% w/v) to obtain primary aggregates with a size of less than 20 nm and stabilized using 0.3-0.6% (w/v) of polymers alone or in combination of Gum Arabic or Gum acacia, pectin and an anionic polymer selected from Sodium Carboxy methyl cellulose, Hydroxy

Propyl Methyl Cellulose and poly vinyl alcohol (0.05-5% w/v) to tailor cluster sizes of less than 100 nm that are stable up to 50° C. Zeta Potential of the compositions is maintained greater than −25 mV even up to 50° C.

In another aspect of the invention, acid selected from boric acid, benzoic acid, citric acid, silicic acid and salicylic acid at a concentration of 0.1-0.5% (w/v) is added to the compositions.

In another aspect of the invention, 0.06-0.1% (w/v) of streptomycin sulphate or 0.015-0.5% (w/v) of Benzalkonium chloride or sulphur dioxide, or combinations thereof is added to the compositions prior to packaging.

In another aspect of the invention, multi-functional chemical moieties such as amino, nitrogen, sulphur, boron, etc. maybe incorporated in the composition.

The method of preparation of the aqueous fertiliser compositions containing stabilized nano clusters of ≤100 nm of the present invention comprises steps:
i) Preparing an aqueous solution of urea
ii) Optionally, dissolving thiourea in the urea solution,
iii) Optionally, dissolving a first ammonium salt in the urea solution,
iv) Optionally, dissolving a second ammonium salt in the solution obtained in step ii,
v) Mixing a non-ionic surfactant in the solution obtained in steps (i)/(ii)/(iii)/(iv),
vi) Separately preparing an aqueous solution of a polymer,
vii) Adding and mixing anionic Polymer in solution (vi)
viii) Adding and mixing amino acid in the solution of step (vii), followed by optional addition of acid,
ix) Mixing the solution obtained in step (v) to the solution obtained in step (viii),
X Optionally, adding anti-microbial agents in the solution obtained in step (x) prior to packaging.

The sequence of mixing as described in steps (ii), (iii) and (iv) may be reversed.

The sequence of mixing as described in step (ix) may be reversed.

The solutions are mixed by stirring or ultra-sonication.

The nitrogen source comprises of urea (5 to 35% w/v), optionally a first ammonium salt (1-10% w/v) and optionally a second ammonium salt (3-20% w/v) and optionally Thio Urea (1-13%). The first ammonium salt is selected from mono or di ammonium phosphates the second ammonium salt is selected from ammonium sulphate and ammonium nitrate. The non-ionic surfactant (0.5-2.0% w/v) with HLB value ranging from 8-18 and saponification value between 35 and 55 is selected from Polysorbates or polyglycerol and the mixtures thereof. The amino acid (0.1-1% w/v) is selected from glycine and glutamic acid. The polymer is selected alone or in combination from Gum Arabic/Acacia gum or Pectin (0.3-0.6% w/v) and an anionic polymer is selected from

Sodium Carboxy methyl cellulose, Hydroxy Propyl Methyl Cellulose and Poly Vinyl alcohol (0.05-5% w/v). The acid (0.1-0.5% w/v) is selected from boric acid, benzoic acid, citric acid, silicic acid and salicylic acid. The antimicrobial agents is selected optionally from streptomycin sulphate (0.06-0.1% w/v) or 0.015-0.5% (w/v) of Benzalkonium chloride or sulphur dioxide, or combinations thereof. Further, multi-functional chemical moieties such as amino, nitrogen, sulphur, boron, etc. maybe incorporated in the composition

The process for the preparation of aqueous fertiliser compositions containing stabilized nano clusters of ≤100 nm provides a “Green Technology” that is ecologically safe as no effluents or gases are generated thereby providing that is.

The invention is illustrated with non-limiting examples.

### Example 1: Preparation of Aqueous Fertiliser Composition using Urea as Nitrogen Source

Solution 1: 100 kg of urea was dissolved in 440 litres of deionized water. To this solution 17 liters of Tween 20 was added with stirring to obtain a clear solution.
Solution 2: 0.5 kg of Sodium Carboxy methyl cellulose was dissolved in 440 liters of deionized water. 4 kg of Gum arabic was added with stirring to obtain a mixture of the two polymers. 1 kg of glycine was dissolved in the mixture of the polymers and 2 kg of Boric acid was added to the solution to obtain a clear solution.
Final Composition: Solutions 1 and 2 were mixed with stirring; 0.03% of SO₂ was purged in in the solution and made up to 100% with water to obtain the final composition. Particle size analysis and zeta potential of the composition is presented in FIG. 4. The mean hydrodynamic diameter was 34.32 nm and the zeta potential of the composition was −38.7 mV.

### Example 2: Preparation of Aqueous Fertiliser Composition Using Urea: 1^{st} Ammonium Salt Mono Ammonium Phosphate: 2^{nd} Ammonium salt, Ammonium Sulphate in the Ratio of 3:1:1

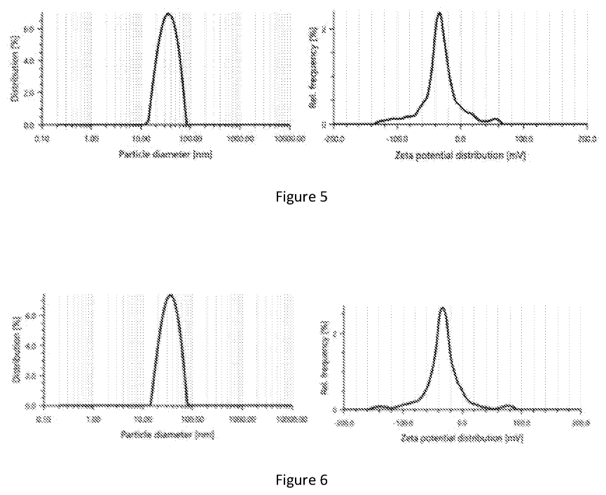

Solution 1: 180 kg of urea was dissolved in 400 liters of deionized water. To this solution, 60 kg of mono ammonium phosphate was dissolved followed by addition of 60 kg of Ammonium sulphate to obtain a clear solution. To this solution 15 liters of Tween 20 was added with stirring to obtain a clear solution.
Solution 2: 0.8 kg of sodium carboxy methyl cellulose was dissolved in 280 liters of deionized water. 3.5 kg of gum arabic was added with stirring to obtain a mixture of the two polymers. 1.0 kg of glycine was dissolved in the mixture of the polymers. 1.5 kg of boric acid was added to obtain a clear solution.
Final composition: Solutions 1 and 2 were mixed with stirring; 1 kg of benzalkonium chloride was added. Then, 0.025% of SO₂ was purged in in the solution and made up to 100% with water to obtain the final composition. Particle size analysis and zeta potential of the composition is presented in FIG. 5. The mean hydrodynamic diameter was 34.77 nm and the zeta potential of the composition was −38.2 mV.

### Example 3: Preparation of Aqueous Fertiliser Composition Using Urea to 1^{st} Ammonium Saltmono Ammonium Phosphate to 2^{nd} Ammonium Salt Ammonium Sulphate in the Ratio of 2.5:1:1.5

Solution 1: 100 kg of urea was dissolved in 440 litres of deionized water. To this solution, 40 kg of mono ammonium phosphate was dissolved followed by addition of 60 kg of Ammonium sulphate with stirring to obtain a clear solution. To this solution 17 liters of Tween 20 was added with stirring to obtain a clear solution.
Solution 2: 0.5 kg of Sodium Carboxy methyl cellulose was dissolved in 340 liters of deionized water. 4 kg of Gum arabic was added with stirring to obtain a mixture of the two polymers. 1 kg of glutamic acid was dissolved in the mixture of the polymers and 2 kg of Boric acid was added to the solution to obtain a clear solution.
Final composition: The solutions 1 and 2 were mixed with stirring; 1 kg of benzalkonium chloride was added and made up to 100% with water to obtain the final composition. Particle size analysis and zeta potential of the composition is presented in FIG. 6. The mean hydrodynamic diameter was 34.15 nm and the zeta potential of the composition was −34.9 mV.

### Example 4: Preparation of Aqueous Fertiliser Composition Using Urea to 1^{st} Ammonium Salt, Diammonium Phosphate to 2^{nd} Ammonium Salt, Ammonium Sulphate in the Ratio of 2:1:2

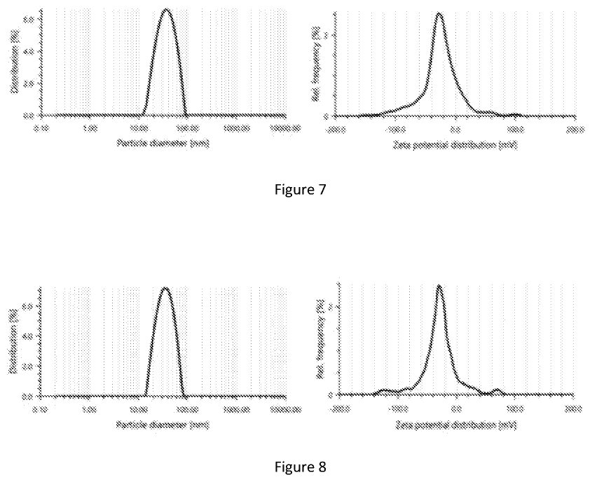

Solution 1: 80 kg of urea was dissolved in 440 liters of deionized water. To this solution, 40 kg of diammonium phosphate was dissolved followed by addition of 80 kg of Ammonium sulphate to obtain a clear solution. To this solution 16 liters of Tween 80 was added with stirring to obtain a clear solution.
Solution 2: 0.5 kg of hydroxy propyl methylcellulose was dissolved in 340 liters of deionized water. 4.2 kg of pectin was added with stirring to obtain a mixture of the two polymers. 1.2 kg of glycine was dissolved in the mixture of the polymers. 1.5 kg of citric acid was added to obtain a clear solution.
Final Composition: Solutions 1 and 2 were mixed with stirring; 0.025% of SO₂ was purged in in the solution and made up to 100% with water to obtain the final composition. Particle size analysis and zeta potential of the composition is presented in FIG. 7. The mean hydrodynamic diameter was 35.02 nm and the zeta potential of the composition was −32 mV.

### Example 5: Preparation of Aqueous Fertiliser Composition Using Urea to 1^{st} Ammonium Salt Mono Ammonium Phosphate to 2^{nd} Ammonium Salt Ammonium Nitratein the Ratio of 3:1:1

Solution 1: 90 kg of urea was dissolved in 430 liters of deionized water. To this solution, 30 kg of mono ammonium phosphate was dissolved followed by addition of 30 kg of ammonium nitrate to obtain a clear solution. To this solution 17 liters of Polyglycerol was added with stirring to obtain a clear solution.
Solution 2: 0.5 kg of Carboxy Methylcellulose was dissolved in 350 liters of deionized water. 4 kg of pectin was added with stirring to obtain a mixture of the two polymers. 1 kg of glutamic acid was dissolved in the mixture of the polymers. Then, 2 kg of boric acid was added to obtain a clear solution.
Final Composition: Solution 1 and Solution 2 were mixed and 1 kg of Benzalkoniumchloride was added and 0.015% of SO₂ was purged and the volume was made up to 100% with water to obtain the final composition. Particle size analysis and zeta potential of the composition is presented in FIG. 8. The mean hydrodynamic diameter was 34.64 nm and the zeta potential of the composition was −35.1 mV.

### Example 6: Preparation of Aqueous Fertiliser Composition using Urea to 1^{st} Ammonium Salt Mono Ammonium Phosphate to 2^{nd} Ammonium Salt Ammonium Nitrate in the Ratio of 7.5:1:2.5

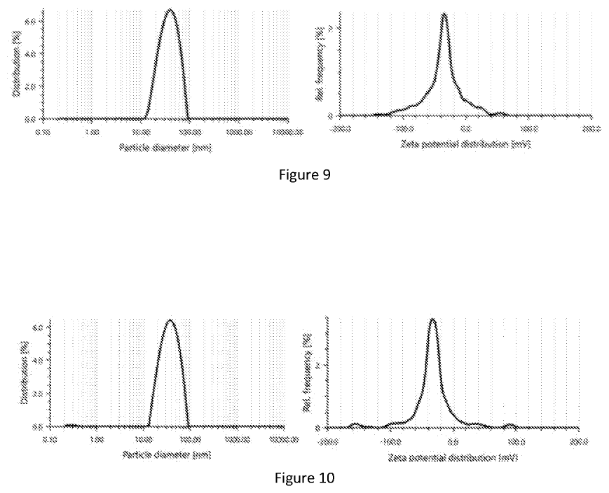

Solution 1: 300 kg of urea was dissolved in 470 liters of deionized water. To this solution, 40 kg of mono ammonium phosphate was dissolved followed by addition of 100 kg of ammonium nitrate to obtain a clear solution. To this solution 15 liters of Polyethylene glycol was added with stirring to obtain a clear solution.
Solution 2: 3 kg of Carboxy Methylcellulose was dissolved in 63 liters of deionized water. 5 kg of Poly vinyl alcohol was added with stirring to obtain a mixture of the two polymers. 1 kg of glutamic acid was dissolved in the mixture of the polymersto obtain a clear solution.
Final Composition: Solution 1 and Solution 2 were mixed and 1 kg of Benzalkonium chloride was added and 0.015% of SO₂ was purged and the volume was made up to 100% with water to obtain the final composition. Particle size analysis and zeta potential of the composition is presented in FIG. 9. The mean hydrodynamic diameter was 33.9 nm and the zeta potential of the composition was −36.1 mV.

### Example 7: Preparation of Aqueous Fertiliser Composition Using Urea to Thio Urea in the Ratio of 3:1

Solution 1: 360 kg of urea was dissolved in 450 liters of deionized water. To this solution, 120 kg of thio urea was dissolved to obtain a clear solution. To this solution 12 liters of Polyglycerol was added with stirring to obtain a clear solution.
Solution 2: 10 kg of Carboxy Methylcellulose was dissolved in 80 liters of deionized water. 5 kg of Pectin was added with stirring to obtain a mixture of the two polymers. 1 kg of glutamic acid was dissolved in the mixture of the polymers. Then, 2 kg of glycine was added to obtain a clear solution.
Final composition: Solution 1 and Solution 2 were mixed and 1 kg of Benzalkonium chloride was added and 0.015% of SO₂ was purged and the volume was made up to 100% with water to obtain the final composition. Particle size analysis and zeta potential of the composition is presented in FIG. 10. The mean hydrodynamic diameter was 34.48 nm and the zeta potential of the composition was −36.1 mV.

### Example 8: Preparation of Aqueous Fertiliser Composition Using Urea to Thio Urea in the Ratio of [7:1] and Urea to 1^{st} Ammonium Salt Mono Ammonium Phosphate to 2^{nd} Ammonium Salt Ammonium Sulphate is in the Ratio of [5.6:1:2]

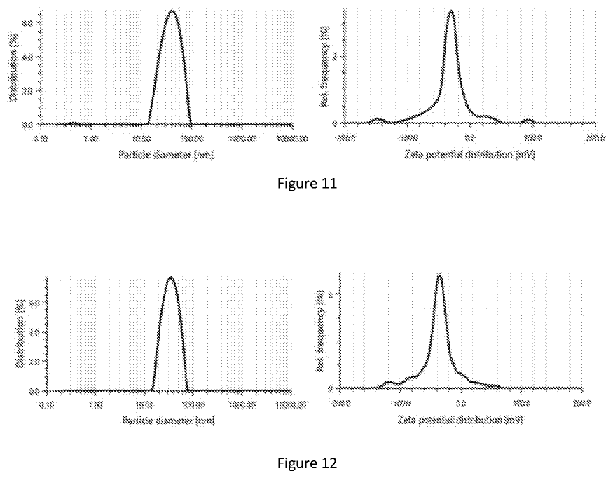

Solution 1: 280 kg of urea was dissolved in 500 liters of deionized water. To this solution, 40 kg of thio urea was dissolved followed by 50 kg of Mono Ammonium phosphate and finally 100 kg of Ammonium sulphate is added and dissolved to obtain a clear solution. To this solution 10 liters of Polyethylene glycol was added with stirring to obtain a clear solution.
Solution 2: 5 kg of Carboxy Methylcellulose was dissolved in 80 liters of deionized water. 5 kg of Poly Vinyl Alcohol was added with stirring to obtain a mixture of the two polymers. 1 kg of succinic acid was dissolved in the mixture of the polymers followed by 5 kg of glycine is added and dissolved to obtain a clear solution.
Final Composition: Solution 1 and Solution 2 were mixed and 1 kg of Benzalkonium chloride was added and 0.015% of SO₂ was purged and the volume was made up to 100% with water to obtain the final composition. Particle size analysis and zeta potential of the composition is presented in FIG. 11. The mean hydrodynamic diameter was 37.6 nm and the zeta potential of the composition was −36.8 mV.

### Example 9: Preparation of Aqueous Fertiliser Composition Using Urea to Thio Urea in the Ratio of [3:1] and Urea to 1^{st} Ammonium Salt Mono Ammonium Phosphate in the Ratio of [1:1]

Solution 1: 300 kg of urea was dissolved in 500 liters of deionized water. To this solution, 100 kg of thio urea was dissolved followed by 300 kg of Mono Ammonium phosphate is added and dissolved to obtain a clear solution. To this solution 10 liters of Polyethylene glycol was added with stirring to obtain a clear solution.
Solution 2: 5 kg of Carboxy Methylcellulose was dissolved in 80 liters of deionized water. 5 kg of pectin was added with stirring to obtain a mixture of the two polymers. 1 kg of salicylic acid was dissolved in the mixture of the polymers followed by 5 kg of glutamic acid is added and dissolved to obtain a clear solution.
Final Composition: Solution 1 and Solution 2 were mixed and 1 kg of Benzalkonium chloride was added and 0.015% of SO2 was purged and the volume was made up to 100% with water to obtain the final composition. Particle size analysis and zeta potential of the composition is presented in FIG. 12. The mean hydrodynamic diameter was 34.27 nm and the zeta potential of the composition was −36.7 mV.

### Example 10: Preparation of Aqueous Fertiliser Composition Using Urea to Thio Urea in the Ratio of [3.2:1] and Urea to 2^{nd} Ammonium Salt Ammonium Sulphate in the Ratio of [3.2:1]

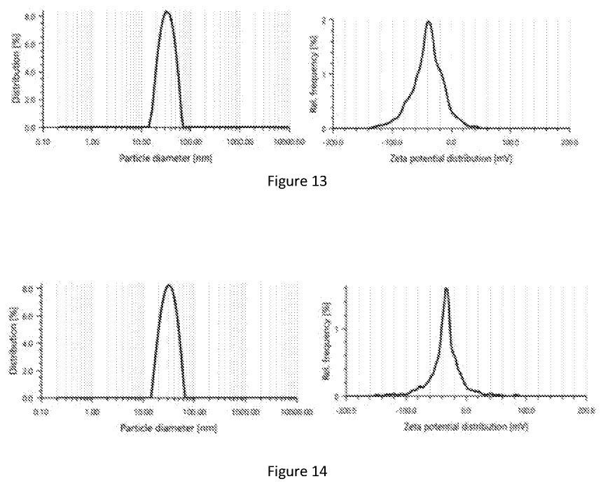

Solution 1: 320 kg of urea was dissolved in 500 liters of deionized water. To this solution, 100 kg of thio urea was dissolved followed by 100 kg of Ammonium sulphate is added and dissolved to obtain a clear solution. To this solution 10 liters of Polyethylene glycol was added with stirring to obtain a clear solution.
Solution 2: 5 kg of Carboxy Methylcellulose was dissolved in 80 liters of deionized water. 5 kg of pectin was added with stirring to obtain a mixture of the two polymers. 1 kg of salicylic acid was dissolved in the mixture of the polymers followed by 5 kg of glutamic acid is added and dissolved to obtain a clear solution.
Final Composition: Solution 1 and Solution 2 were mixed and 1 kg of Benzalkonium chloride was added and 0.015% of SO₂ was purged and the volume was made up to 100% with water to obtain the final composition. Particle size analysis and zeta potential of the composition is presented in FIG. 13. The mean hydrodynamic diameter was 33.09 nm and the zeta potential of the composition was −33.7 mV.

### Example 11: Preparation of Aqueous Fertiliser Composition Using Urea to 1nd Ammonium Salt Mono Ammonium Phosphate in the Ratio of 2.6:1

Solution 1: 360 kg of urea was dissolved in 450 liters of deionized water. To this solution, 140 kg of Mono Ammonium phosphate is added and dissolved to obtain a clear solution. To this solution 10 liters of Polyethylene glycol was added with stirring to obtain a clear solution.
Solution 2: 5 kg of Carboxy Methylcellulose was dissolved in 60 liters of deionized water. 5 kg of pectin was added with stirring to obtain a mixture of the two polymers. 1 kg of silicic acid was dissolved in the mixture of the polymers followed by 5 kg of glutamic acid is added and dissolved to obtain a clear solution.
Final Composition: Solution 1 and Solution 2 were mixed and 1 kg of Benzalkonium chloride was added and 0.015% of SO₂ was purged and the volume was made up to 100% with water to obtain the final composition. Particle size analysis and zeta potential of the composition is presented in FIG. 14. The mean hydrodynamic diameter was 31.13 nm and the zeta potential of the composition was −32.2 mV.

### Example 12: Preparation of Aqueous Fertiliser Composition Using Urea to 2^{nd} Ammonium Salt Ammonium Sulphate in the Ratio of 1:1

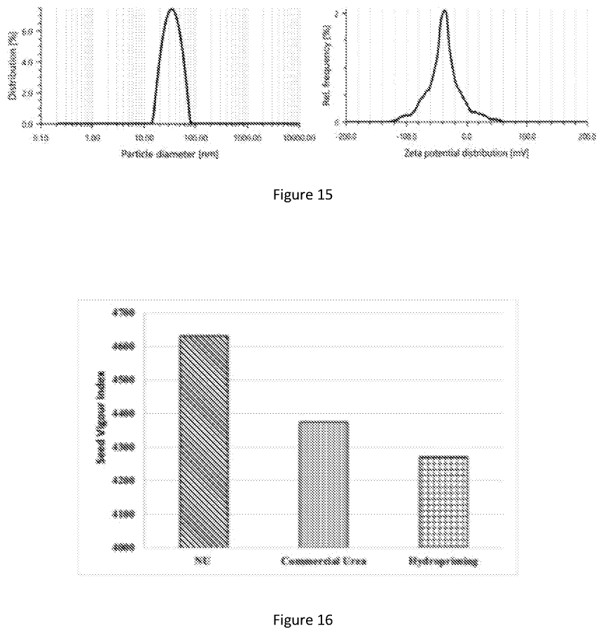

Solution 1: 300 kg of urea was dissolved in 450 liters of deionized water. To this solution, 300 kg of Ammonium sulphate is added and dissolved to obtain a clear solution. To this solution 10 liters of Polyethylene glycol was added with stirring to obtain a clear solution.
Solution 2: 5 kg of Carboxy Methylcellulose was dissolved in 60 liters of deionized water. 5 kg of pectin was added with stirring to obtain a mixture of the two polymers. 1 kg of silicic acid was dissolved in the mixture of the polymers followed by 5 kg of glutamic acid is added and dissolved to obtain a clear solution.
Final Composition: Solution 1 and Solution 2 were mixed and 1 kg of Benzalkonium chloride was added and 0.015% of SO2 was purged and the volume was made up to 100% with water to obtain the final composition. The final composition was analyzed for particle size and zeta potential and is presented in FIG. 15. The mean hydrodynamic diameter was 33.2 nm and the zeta potential of the composition was −34.9 mV.

### Example 13: Preparation of Aqueous Fertiliser Composition Using Urea to 1^{nd} Ammonium Salt Mono Ammonium Phosphate to 2^{nd} Ammonium Salt Ammonium Sulphate in the Ratio of 3:1:2 in Aqueous Media With Water and Organic Solvent

Solution 1: 300 kg of urea was dissolved in 450 liters of aqueous solution of ethanol (5%). To this solution, 100 kg of mono ammonium phosphate is added followed by 200 kg of Ammonium sulphate is added and dissolved to obtain a clear solution. To this solution 8 liters of Polyethylene glycol was added with stirring to obtain a clear solution.
Solution 2: 3 kg of Carboxy Methylcellulose was dissolved in 60 liters of deionized water. 4.2 kg of Gum arabic was added with stirring to obtain a mixture of the two polymers. 1 kg of silicic acid was dissolved in the mixture of the polymers followed by 5 kg of glycine is added and dissolved to obtain a clear solution.
Final Composition: Solution 1 and Solution 2 were mixed and 0.5 kg of Benzalkonium chloride was added and 0.025% of SO₂ was purged and the volume was made up to 100% with water to obtain the final composition.

### Example 14: Preparation of Aqueous Fertiliser Composition Using Urea to Thio Urea [6:1] and Urea to 1^{st} Ammonium Salt Mono Ammonium Phosphate to 2^{nd} Ammonium Salt Ammonium Sulphate in the Ratio of [3:1:1] In Aqueous Media With Water and Organic Solvent

Solution 1: 300 kg of urea was dissolved in 420 liters of aqueous solution of acetone (5%). To this solution, 50 kg of thio urea was then dissolved in the solution. To it, 100 Kg of Mono ammonium Phosphate is added followed by 100 kg of Ammonium sulphate is added and dissolved to obtain a clear solution. To this solution 8 liters of Polyethylene glycol was added with stirring to obtain a clear solution.
Solution 2: 3 kg of Carboxy Methylcellulose was dissolved in 60 liters of deionized water. 4.2 kg of Gum arabic was added with stirring to obtain a mixture of the two polymers. 1 kg of Boric acid was dissolved in the mixture of the polymers followed by 5 kg of glycine is added and dissolved to obtain a clear solution.
Final Composition: Solution 1 and Solution 2 were mixed and 0.5 kg of Benzalkonium chloride was added and 0.025% of SO₂ was purged and the volume was made up to 100% with water to obtain the final composition. Samples for analysis of pH, EC, Size, Zeta and Viscosity were drawn from the reaction mixture at the end of step A, step B and final composition.

Parameters indicative of storage stability of the composition are no physical changes in appearance including phase separation and/or precipitation, retention of cluster sizes, particle size distribution, Z-average, distribution and poly dispersity index, retention of zeta potential, pH, viscosity, and density.

TEM imaging of the compositions were carried out from time to time to assess the stability of the clusters. Total nitrogen analysis and centrifugation test (Lachman et al., 1994) were performed to assess quality of the product.

In-vitro and in-vivo experiments were done to establish the efficacy of the compositions of the invention.

### Example 15: Stability of the Aqueous Fertiliser Composition of the Present Invention

The compositions of example 1-6 were centrifuged at 3000 rpm for 15 min. There was no phase separation or sedimentation on centrifugation.

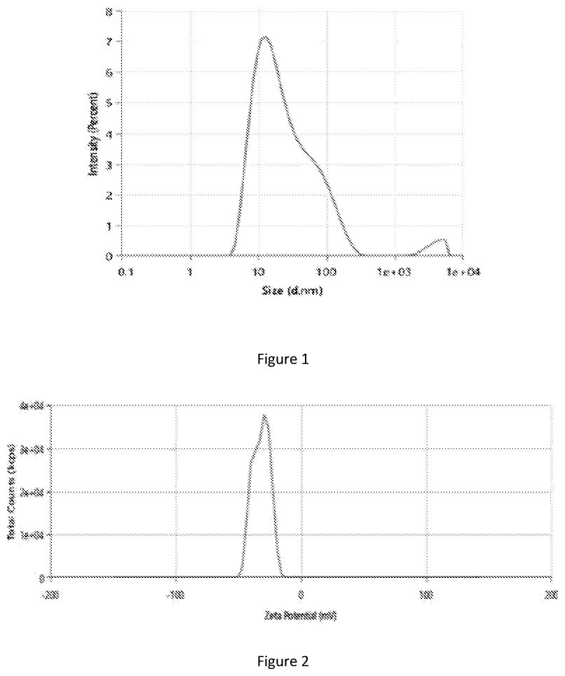

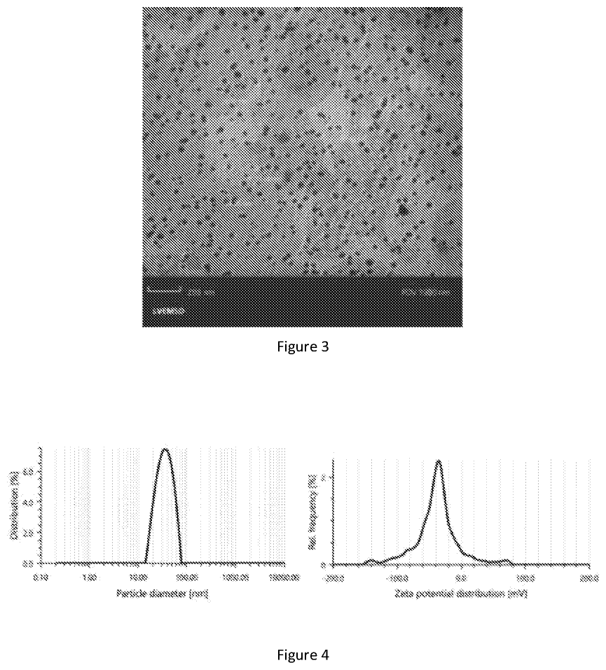

The cluster sizes (particle size) of the aqueous fertiliser composition were measured using Dynamic Light Scattering technique by Particle size analyzer (model: Litesizer 600). The hydrodynamic diameter ranged between 20-40 nm and more than 80% of the particles were distributed between 20 to 100 nm. The size distribution remained stable even after the composition was exposed to elevated temperatures up to 50° C. The results of composition in example 1 are presented in FIGS. 1 and 2. TEM image further confirms the uniform particle distribution and morphology (FIG. 3).

The zeta potential of the compositions was greater than −25 mV. The values remained unchanged and with no change in appearance even when the composition were subjected to temperatures >50° C. Table 1 is characterization of aqueous fertiliser composition of the present invention.

TABLE 1
Characterization of aqueous fertiliser composition

| | | |
|---|---|---|
| | Results at room | Results at |
| Parameter | temperature | 50° C. |

| | | | | |
|---|---|---|---|---|
| Particle size (Z-average) | 20-40 | nm | 20-50 | nm |

| | | |
|---|---|---|
| Particle Size Distribution | Less than 100 nm | Less than 100 nm |

| | | | | |
|---|---|---|---|---|
| Zeta potential | >−25 | mV | >−25 | mV |

| | | |
|---|---|---|
| pH | Less than 8.0 | Less than 8.0 |
| Physical appearance | Clear solution | Clear solution |

| | | | | |
|---|---|---|---|---|
| Viscosity | 5-15 | cP | 5-15 | cP |

| | | |
|---|---|---|
| Total Nitrogen (% w/v) | 4-20 | 4-20 |

### Example. 16: Study of Surface Tension and Dynamic Contact Angle of Aqueous Fertiliser Composition of Example 5 on Maize Leaf (Zea mays)

Force tensiometer—Kruss (Tensiio K100) was used to measure the surface tension of the liquids that utilizes Du Nouy ring method (ASTM D971). 5ml of the composition of example 5 was diluted with 950 ml of water to achieve an aqueous fertiliser composition spray solution. Surface tension of the diluent (water) for any foliar agro chemicals was 71.34 mN/m, whereas surface tension of aqueous fertiliser composition spray solution of example 5 was 28.66 mN/m. For any spray solution the most desired surface tension required for better wettability is 25-30mN/m and the surface tension of the aqueous fertiliser composition spray solution falls within the range and demonstrates the desired drift potential resulting in uniform coverage during foliar spray.

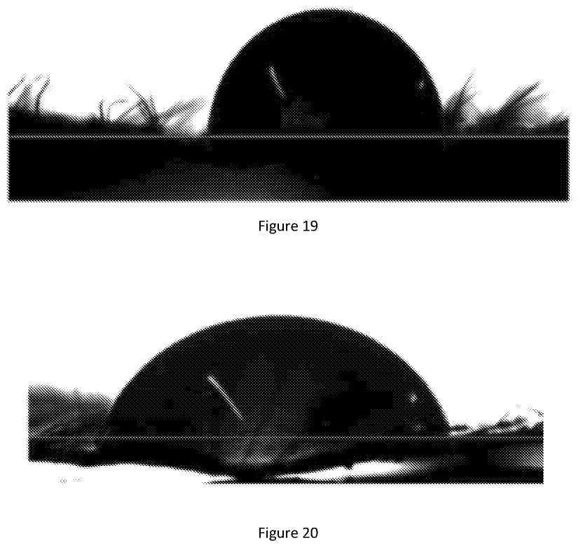

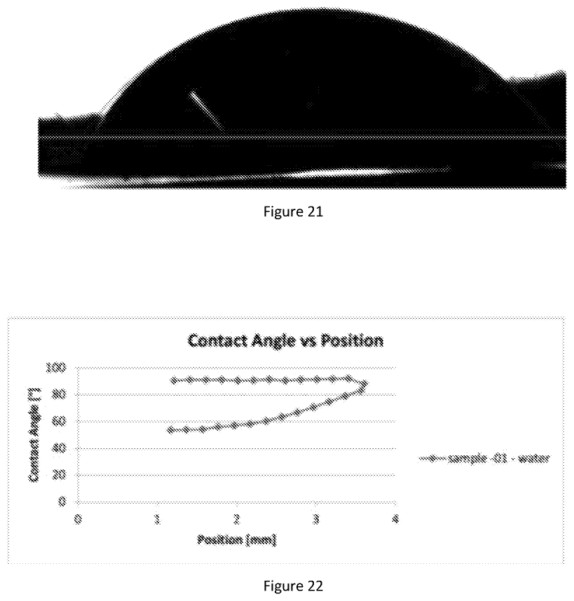

Static contact angle of the aqueous fertiliser composition spray solution and the diluent was measured using sessile drop technique (Marmur 2006; Erbil 2014; Wan et al. 2014) on a maize leaf. The contact angle of diluent on Maize leaf (Zea mays) was 89.2° (FIG. 19); the contact angle of Urea solution (2%) was 76.2° (FIG. 20); the contact angle of aqueous fertiliser composition spray solution of example 5 was 48.5° (FIG. 21). The reduced contact angle of aqueous fertiliser composition provides the desired foliar spray when compared to only urea solution (2%).

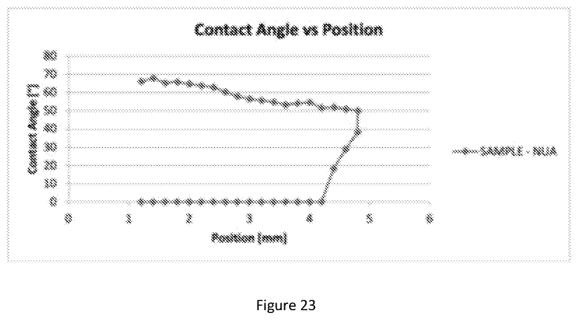

Dynamic contact angle of aqueous fertiliser composition spray solution and diluent (water) was measured using wilhelmy plate method on a maize leaf. The contact angle of diluent on Maize leaf (Zea mays) was 63.83° (FIG. 22) the contact angle of aqueous fertiliser composition spray solution was 2.41° (FIG. 23).

Leaves are classified as non-wettable if contact angle θ>110°, and θ>150° for leaves are considered super hydrophobic. Similarly, leaves are considered as highly wettable if θ<90°. For aqueous fertiliser composition spray solution, the contact angle was <90° and demonstrated super wettability thereby ensuring superior uptake of nano nutrient clusters into the plant system.

### Example 17: Spectrometric Determination of Total Chlorophyll Resulting From Foliar Spray of Aqueous Fertiliser Composition of the Present Invention on Paddy

Analytical determination of total chlorophyll (a+b) by extraction of chlorophyll from treated leaves was performed with spectrophotometer at 662 nm and 644 nm, respectively using the known method described by Arnon (1949).

5 ml of the composition of Example 1 was diluted with 950 ml of water to achieve a spray solution. 20 liters of this diluted solution was sprayed on paddy on the 35^{th} day after transplanting in variety CO 51 in an area of 400 m².

Total chlorophyll was calculated using the formula:

$$Total chlorophyll = \frac{20.2 {A}_{645} + 8.02 {A}_{645} \times V}{a \times 1000 \times W}$$

$$where ,$$

$$a = length of path light in the cell ( usually 1 cm )$$

$$v = volume of the extract in ml$$

$$w = weight of the sample in g$$

TABLE 2
Effect of diluted spray solution of aqueous fertiliser composition
of Example 1 on Total chlorophyll content in paddy (CO 51)

| | | Total Chlorophyll(mg/gFresh weight) | | |
|---|---|---|---|---|
| | | | Foliar application | |
| | | | of diluted | |
| | | Conventional | aqueousfertiliser | Conventional |
| S. | | urea foliar | composition | Urea soil |
| No | Treatments | application | of example 1 | application |
| 1 | Vegetative stage | 1.915 | 2.42 | 1.135 |
| 2 | Tillering | 2.763 | 4.36 | 1.499 |
| 3 | Booting | 3.643 | 5.53 | 1.874 |

*All the results are replications of 10 leaf samples of same-tagged plants in varying stages.

The chlorophyll contents were estimated during major growth stages. The total Chlorophyll content after aqueous fertiliser composition foliar application was significantly higher than the conventional urea foliar application or the conventional urea soil application in all growth stages.

### Example 18: Seed Vigour Test

Seed vigour test was performed to assess bio-efficacy. The “Roll Towel Technique” was used to test the seeds for Germination percentage, Root length, Shoot length, Fresh weight and dry weight.

4 ml of aquous fertilizer compositions of example 2, 7 and 8 was diluted in 996 ml of water and used to test the effect on seed vigour index in maize.

The vigour index of the seedlings was estimated using the formula (Abdul baki and Anderson, 1973):

$$Root length ( cm ) + Shoot length ( cm ) * Germination percentage$$

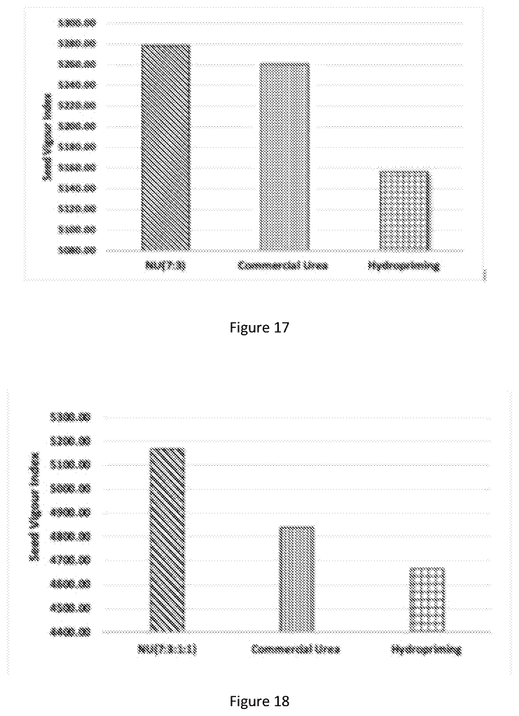

The results are presented in FIGS. 16, 17 and 18.

FIGS. 16, 17 and 18 clearly demonstrate the higher performance of the seeds treated with the diluted aqueous fertiliser compositions of the present invention (examples 2, 7 and 8 respectively) as compared to the results of seeds treated with conventional urea or subjected to hydro-priming.

### Example 19: Biosafety of the Aqueous Fertiliser Composition of the Present Invention

Biosafety studies were conducted on beneficial organisms such as parasitoids, predators and Honey bees, using guidelines from OECD (Organization for Economic Cooperation and Development), Testing methodology and the concept of the IOBC

(International Organization for Biological and integrated Control) working groups (Ref: Hassan, S.A.. Pesticides and non-target invertebrates/Wimborne, Dorset, England: Intercept, 1989, editor: Paul C. Jepson). Tests were carried out using aqueous fertiliser compositions of the present invention of example 8 at dilution of 100 and 200 times against the test organisms.

The results are presented in tables 3, 4, 5 and 6. The data obtained were analysed in completely randomized design. The data on mortality per cent were transformed into arc sine values. Further, the treatment means were statistically differentiated by performing Least Square Means test (LSD) at p<0.05 levels.

The results demonstrate that the aqueous fertiliser compositions of the present invention are bio safe against beneficial organisms such as parasitoids, predators and Honey bees. Table 3 confirms that aqueous fertiliser composition of the present invention did not show any inhibitiory effect on adult emergence of Trichogrammachilonis. Table 4 and Table 5 confirm the biosafety of the aqueous fertiliser compositions of the present invention against green lacewing as there was no negative impact on egg hatchability and survivability. Table 6 also confirms the biosafety of aqueous fertiliser compositions against Indian honeybees. Statistical analysis and non-significant variation between treatments as detailed in the table 3, 4, 5 & 6 confirm that the aqueous fertiliser compositions under study are biosafe.

TABLE 3
Bio-safety of aqueous fertiliser composition (afc) of the present
invention of example 8towards Trichogrammachilonisegg parasitoid

| | | Adult | Corrected | Egg | Un- | Corrected |
|---|---|---|---|---|---|---|
| S. | | emergence | Mortality | parasitization | parasitized | Mortality |
| No. | Treatments | (%) | (%) | (%) | eggs (%) | (%) |
| 1 | 5 ml (afc) diluted to 1 | 97.00 | 2.51 | 96.50 | 3.50 | 2.03 |
| | literwith water | (80.99)** | | (79.34)** | | |
| 2 | 10 ml (afc) diluted to 1 | 95.50 | 4.02 | 95.00 | 5.00 | 3.55 |
| | liter with water | (78.98)** | | (77.43)** | | |
| 3 | Untreated control | 99.50** | — | 98.50** | 1.50 | — |
| | | (86.89) | | (84.14) | | |
| | CV (%) | 4.49 | | 4.09 | | |
| | CD (0.05) | 4.15 | | 3.68 | | |

**non-significant variation FIGS in parentheses are square root transformed values for better interpretation of results

TABLE 4
Bio-safety of aqueous fertiliser composition of
the present invention of example 8 against Green
lacewings Chrysoperlazastrowisillemi eggs

| S. | | Egg hatchability | Per cent | Corrected |
|---|---|---|---|---|
| No. | Treatments | (48HAT) | mortality | mortality |
| 1 | 5 ml (afc) diluted to 1 | 95.50 | 4.50 | 1.55 |
| | liter with water | (79.34)^{b} | (12.24)^{c} | |
| 2 | 10 ml (afc) diluted to | 92.00 | 8.00 | 5.15 |
| | 1 liter with water | (77.43)^{b} | (16.43)^{a} | |
| 3 | Untreated control | 97.00 | 3.00 | — |
| | | (84.14)^{a} | (9.97)^{b} | |
| | CV (%) | 4.088 | 1.50 | |
| | CD (0.05) | 3.68 | 0.21 | |

In a column, means followed by a common alphabets are not significantly different by DMRT (P = 0.05).
Figures in parentheses are square root transformed values

TABLE 5
Bio-safety of aqueous fertiliser composition of
the present invention of example 8 against Green
lacewings Chrysoperlazastrowisillemi eggs

| S. | | Egg hatchability | Per cent | Corrected |
|---|---|---|---|---|
| No. | Treatments | (%)(48HAT) | mortality | mortality |
| 1 | 5 ml (afc) diluted to | 95.50 | 4.50 | 1.55 |
| | 1 liter with water | (79.34)** | (12.24) | |
| 2 | 10 ml (afc) diluted to | 92.00 | 8.00 | 5.15 |
| | 1 liter with water | (77.43)** | (16.43) | |
| 3 | Untreated control | 97.00** | 3.00 | — |
| | | (84.14) | (9.97) | |
| | CV (%) | 5.20 | 1.50 | |
| | CD (0.05) | 4.10 | 0.21 | |

**non-significant variation.
Figures in parentheses are square root transformed values

TABLE 6
Bio-safety of aqueous fertiliser composition of the oresent invention
of example 8 against Indian bees-Apiscerana indica

| | | 6HAT | | | |
|---|---|---|---|---|---|
| | | Per cent | | 24HAT | |
| S. | | mor- | Corrected | Per cent | Corrected |
| No. | Treatments | tality | mortality | mortality | mortality |
| 1 | 5 ml (afc) diluted | 1.00** | 1.00 | 2.50** | 0.55 |
| | to 1 liter with water | (5.73) | | (9.09) | |
| 2 | 10 ml (afc) diluted | 2.50** | 2.50 | 4.00** | 2.02 |
| | to 1 liter with water | (9.09) | | (11.45) | |
| 3 | Untreated control | 0.00 | 0 | 2.00 | 0 |
| | | (0.28) | | (8.12) | |

| | | |
|---|---|---|
| CV (%) | 4.177 | 3.199 |
| CD (0.05) | 0.236 | 0.343 |

**non-significant variation
Figures in parentheses are square root transformed value

Advantages of the aqueous fertiliser composition of the present invention over the prior art are as follows:
Nitrogen containing chemical entities in tailored matrices retain their cluster sizes <100 nm with Z-average of 20 to 40 nm even on storage at temperature up to 50° C.
has zeta potential (Greater than −25 mV) and pH (<8) which meet the specification of such products.
demonstrates ionic balance and pH stability and provides balanced nitrogen nutrition to crops with higher use efficiency.
remains stable without phase separation, precipitation, gel formation etc. and ensures better absorption by leaves during foliar spray.
exhibits desirable spreadability and absorption of the droplets on diverse surfaces thereby enhancing bio efficacy when used under different field application methods such as seed treatment, seedling dip and foliar spray.
is eco and bio safe and does not show any toxic effect on beneficial organisms such as honey bees and natural predators in agriculture.
manufacturing process is easily scalable to industrial operations in a cost-effective manner.

1-22. (canceled)

23. An aqueous fertiliser composition containing stabilized nano clusters of ≤100 nm comprising a nitrogen source, a non-ionic surfactant, an amino acid, a polymer matrix, optionally an acid, antimicrobial agents, and multi-functional chemical moieties such as amino, nitrogen, sulphur, boron;
wherein, the non-ionic surfactant is in a range from 0.5-2% w/v, the polymer matrix is in a range from 0.05-5% w/v, the amino acid is in a range from 0.1-1% w/v,
wherein the nitrogen source is selected from urea, thiourea, a first ammonium salt, a second ammonium salt, or combinations thereof;
wherein the nitrogen source comprises,
i) (urea):(first ammonium salt):(second ammonium salt) in a ratio of (1-7):(1-7):(1-7), or
ii) (urea):(thiourea) in a ratio of (1-8):(1-4), or
iii) (urea):(first ammonium salt) in a ratio of (1-4):(1-3), or
iv) (urea):(second ammonium salt) in a ratio of (1-10):(1-10). or
v) (urea):(thiourea):(first ammonium salt) in a ratio of (1-6):(1-3):(1-4), or
vi) (urea):(thiourea):(second ammonium salt) in a ratio of (1-5):(1-4):(1-4), or
vii) (urea):(thiourea):(first ammonium salt):(second ammonium salt) in a ratio of (0.5-30):(0.5-3):(1-30):(1-30).

24. The aqueous fertiliser composition as claimed in claim 23, wherein a hydrodynamic diameter of nano cluster particles is in a range from 20-40 nm, and more than 80% of the particles are distributed between 20 to 100 nm.

25. The aqueous fertiliser composition as claimed in claim 23, wherein a Zeta Potential of the aqueous fertiliser composition is ≥−25 mV.

26. The aqueous fertiliser composition as claimed in claim 23, wherein a surface tension of the aqueous fertiliser composition at room temperature is in a range from 25-30 N/m and a static contact angle of the aqueous fertiliser composition on a leaf surface is in a range from 40° C. to 50° C.

27. A process for the preparation of aqueous fertiliser composition containing stabilized nano clusters of ≤100 nm as claimed in claim 23, comprising steps of:
i) preparing an aqueous solution of urea in an aqueous media to obtain a urea solution;
ii) optionally, dissolving thiourea in the urea solution;
iii) optionally, dissolving a first ammonium salt in the urea solution;
iv) optionally, dissolving a second ammonium salt in the solution obtained in the step (ii);
v) mixing a non-ionic surfactant in the solution obtained in step (i) or (ii) or (iii) or (iv);
vi) separately preparing an aqueous solution of a polymer;
vii) adding and mixing an anionic polymer in the solution obtained in step (vi);
viii) adding and mixing amino acid in the solution obtained in step (vii), followed by optionally adding an acid;
ix) mixing the solution obtained in the step (v) to the solution obtained in step (viii);
x) optionally, adding anti-microbial agents in the solution obtained in the step (ix);
wherein, a sequence of mixing as described in the steps (ii), (iii) and (iv) may be reversed;
wherein the sequence of mixing as described in the step (ix) may be reversed; and
wherein the solutions are mixed by stirring or ultra-sonication.

28. The process as claimed in claim 27, wherein the aqueous media is selected from water, or a mixture of water and water miscible organic solvent, wherein the water miscible organic solvent is ≤10% v/v of the aqueous media.

29. The aqueous fertiliser composition as claimed in claim 23, wherein the first ammonium salt is selected from ammonium sulphate and ammonium nitrate, and wherein the second ammonium salt is selected from mono or di ammonium phosphates.

30. The aqueous fertiliser composition as claimed in claim 23, wherein the non-ionic surfactant is selected from polysorbates or polyglycerol or sorbitol or polyethylene glycol or mixtures thereof.

31. The aqueous fertiliser composition as claimed in claim 23, wherein the non-ionic surfactant is selected from those having a HLB value in the range from 8-18 and a saponification value between 35 and 55.

32. The aqueous fertiliser composition as claimed in claim 23, wherein the polymer matrix comprise polymers selected from Gum Arabic or Gum acacia and pectin in a range from 0.3 to 0.6% w/v in combination with anionic polymers preferably sodium carboxy methylcellulose (CMC), hydroxy propyl methyl cellulose and poly vinyl alcohol in a range from 0.05 to 5% w/v.

33. The aqueous fertiliser composition as claimed in claim 23, wherein the amino acid is selected from glycine and glutamic acid.

34. The aqueous fertiliser composition as claimed in claim 23, wherein the acid is selected from boric acid, benzoic acid, citric acid, silicic acid and salicylic acid; and wherein the acid is in a range from 0.1-0.5% (w/v).

35. The aqueous fertiliser composition as claimed in claim 23, wherein the antimicrobial agent is selected from streptomycin sulphate (0.06-0.1% w/v) or (0.015-0.5% w/v) of benzalkonium chloride or sulphur dioxide, or combinations thereof.
